(19) United States
(12) Patent Application Publication
(10) Pub. No.: US 2023/0066728 A1
(43) Pub. Date: Mar. 2, 2023

(54) DEPTH INDICATOR DEVICE FOR PROTECTING A BURIED ASSET

(71) Applicant: Grant Ewan McLean, McCrae (AU)

(72) Inventor: Grant Ewan McLean, McCrae (AU)

(21) Appl. No.: 17/822,415

(22) Filed: Aug. 25, 2022

(30) Foreign Application Priority Data
Aug. 25, 2021 (AU) 2021221787

(51) Int. Cl. F16L 1/11

(52) U.S. Cl. CPC F16L 1/11

(57) ABSTRACT

The disclosure provides a depth indicator device for protecting a buried infrastructure asset, such as a water or gas supply pipeline or an electrical conduit. The device comprises an elongate member having an end region configured to be secured to an infrastructure asset below ground. The elongate member is configured to extend upwards from the infrastructure asset a predetermined distance towards a surface of the ground. When exposed during excavation of the infrastructure asset, the elongate member is adapted to indicate a distance to and/or a further depth of the buried infrastructure asset. The disclosure also provides a kit comprising a fixture or a fitting for a pipeline, such as a ferrule for a water supply pipeline or a gas supply pipeline, and an adapter for connecting a depth indicator device according to the disclosure to the fixture or fitting.

### CROSS-REFERENCE TO RELATED APPLICATION

The present application claims priority to Australian Patent Application No. 2021221787 filed on Aug. 25, 2021. The entire contents of the above-listed application are hereby incorporated by reference for all purposes.

### TECHNICAL FIELD

The present disclosure relates to a depth indicator device, and more particularly to a depth indicator device for protecting a buried asset.

The depth indicator device of the disclosure is particularly designed for use with buried infrastructure assets, such as water or gas pipelines, electrical conduits or optical fibre conduits buried in the ground to provide building services, and it will be convenient to describe the disclosure in this exemplary context. It will be appreciated, however, that the depth indicator device of the disclosure is not limited to such applications and may be used in other applications, such as in construction or mining applications.

### BACKGROUND

The following discussion of background art in this specification should in no way be considered an admission that such background is prior art or that such background art is well known or forms part of the common general knowledge in the field in Australia or in any other country.

As noted above, it is common practise for infrastructure assets, such as water pipelines, gas pipelines, electrical conduits or optical fibre conduits, that deliver services to homes and commercial buildings in urban environments to be buried in the ground, typically at a depth that may range from about one metre to several meters. This is practical and convenient as these infrastructure assets are then out of sight and do not create an impediment to human or vehicle traffic at ground level. Furthermore, being buried in the ground protects these important infrastructure assets from being easily tampered with and also insulates them from greater temperature fluctuations typically experienced at ground level.

One of the consequences of infrastructure assets like water and gas pipelines and electrical conduits being buried in the ground is that, when access to those assets is required for maintenance or repair purposes, excavation is needed. Such excavations are typically performed with heavy machinery, such as a hydraulically powered shovel. Although workers performing an excavation will usually have approximate information of the position (including approx. depth) of a buried asset (e.g., a pipeline), it will firstly be appreciated that this information is not always accurate, and secondly that excavation machinery or equipment itself, while very effective at removing large amounts of earth quickly, typically lacks subtlety or finesse in its operation and poses a risk of damaging the buried asset if the asset is in closer proximity than anticipated by workers operating that equipment.

It would therefore be desirable to provide a device that substantially overcomes or ameliorates one or more of the above disadvantages.

### SUMMARY

According to one broad aspect, the disclosure provides a depth indicator device for protecting a buried asset, especially a buried infrastructure asset, such as a water or gas pipeline or an electrical conduit. The device comprises an elongate member having an end region configured to be secured to the asset below ground, wherein the elongate member is configured to extend upwards from the infrastructure asset a predetermined distance towards a surface of the ground, wherein, when exposed during excavation of the asset, the elongate member is configured to indicate a distance to, and/or a further depth of, the buried infrastructure asset.

In this way, the depth indicator device of the disclosure is able to provide workers conducting an excavation of a buried asset with a forewarning that the asset is within a predetermined distance or further depth. In other words, the device alerts the workers conducting the excavation of proximity to the asset and allows them to adjust the further excavating activity to take greater care and to protect the buried asset from inadvertent damage by the heavy machinery during excavation.

In an embodiment, the elongate member is relatively stiff or rigid. This assists to ensure that the elongate member can be arranged to extend upwards from the buried infrastructure asset towards the surface of the ground. For instance, the elongate member is relatively straight. For example, the elongate member may have the form or a rod or stick or strip. In this way, the length of the elongate member provides a direct line to the buried infrastructure asset.

In an alternative embodiment, the elongate member may comprise a plurality of separate, interconnected elements. These elements may optionally be movable relative to one another, e.g., via hinged or pivot connections. Such hinged or pivot connections may be relatively stiff, so that the elongate member does not easily change its shape, e.g., not without some manual effort by a worker. In this way, the elongate member may be selectively collapsible and/or extendible (e.g., via telescopic or hinged connections) for ease of handling when not deployed in the ground.

In an embodiment, the elongate member is relatively flexible. As an example, it could comprise a plurality of linked or interconnected elements, e.g., in the manner of a chain or the like. Thus, individual elements may be stiff or rigid, but the entire elongate member may still be flexible. Other flexible embodiments are also contemplated. This may have some practicality in certain applications where the elongate member must, in use, be guided around one or more obstacles.

In an embodiment, the elongate member has a substantially constant transverse cross-section or profile. The transverse cross-section or profile may be selected from: I-shaped, L-shaped, C-shaped, X-shaped, Y-shaped, Z-shaped, round or circular. As will be appreciated, for a given material, material thickness and basic size, an I-shaped cross-section or profile (i.e., like a strip or strap) will be more flexible than an angled L-shaped, C-shaped, X-shaped, Y-shaped, Z-shaped, round or circular cross-section. As noted above, the cross-section may then favour certain stiffness or flexibility properties.

In an embodiment, the elongate member comprises a polymer plastic material, such as high-density polyethylene (HDPE), polyethylene (PE), polypropylene (PP). polyvinyl chloride (PVC), polyurethane (PU), or the like. The elongate member may, for example, be formed by extrusion.

In an embodiment, the depth indicator device includes a connector or coupling at the end region of the elongate member to be secured to the infrastructure asset. In this regard, the connector or coupling may include a laterally extending member, such as a plate member, at the lower end of the elongate member to be secured to the asset. The laterally extending member (e.g., plate member) has a transverse or lateral extent (i.e., transverse to a longitudinal axis of the elongate member) that is significantly larger than the transverse cross-section or profile of the elongate member itself. This way, when the depth indicator device is secured to the infrastructure asset in use and is itself covered by earth buried in the ground, the laterally extending member (e.g., plate member) operates to resist a withdrawal force or pulling force on the elongate member that may act or tend to pull it out of the ground. The plate member may be disc-shaped and have a diameter in the range of about 50 mm to 150 mm, or about 100 mm.

In an embodiment, the connector or coupling at the end region of the elongate member may be configured for connection to a pipeline or conduit or may be configured for connection to a fixture or fitting on the pipeline or conduit. In this way, the connector or coupling may comprise a clip or a tie or an adhesive strip (e.g., adhesive tape) for connecting the end region of the elongate member to the infrastructure asset. For example, the connector or coupling may include a zip-tie or similar fastening band that could be used to secure the end region of the elongate member to the asset. To this end, the end region of the elongate member itself, or a laterally extending member (e.g., plate member) at the end thereof, may include a hole or aperture for receiving or threading the tie or band there-through. In another arrangement, the laterally extending member (e.g., plate member) at the end of the elongate member may be configured to seat against an outer surface of the pipeline or conduit. In this regard, the laterally extending member (plate member) may include a recess on an underside thereof that is adapted to receive and/or partially accommodate a pipeline or conduit of the asset, so that the laterally extending member (e.g., plate member) may seat against the pipeline or conduit, e.g., in the manner of a saddle. In that case, the laterally extending member (plate member) may be adapted to be adhesively bonded to the pipeline or conduit, e.g., via an adhesive tape or cement applied between opposing surfaces thereof. Alternatively, the end region of the elongate member may include a clip, e.g., having jaws, designed to receive and to clasp or hold part of the asset. In this regard, the asset may include a fixture or fitting on a pipeline or conduit (e.g., a junction component, such as a ferrule for a water pipeline or a gas pipeline) and the connector or coupling of the depth indicator device may be adapted to be connected to that fixture or fitting.

In an embodiment, the connector or coupling at the end region of the elongate member includes an adapter configured to interface with a pipeline or conduit itself or to interface with a fixture or fitting on the pipeline or conduit. To this end, the adapter may be configured to be attached or connected to a lower end region of the elongate member. In this regard, for example, it may be configured to be attached to the laterally extending member (e.g., plate member) at the end of the elongate member, e.g., by one or more fastener or by adhesive bonding, including adhesive cement or adhesive tape between opposed surfaces. Further, the adapter may also be configured to be attached or connected to an outer surface of the pipeline or conduit itself or, alternatively, to a fixture or fitting on the pipeline or conduit. In the former case, the adapter may include a recess adapted to receive and/or accommodate part of the outer surface of the pipeline or conduit, so that the adapter seats directly against the pipeline or conduit (e.g., like a saddle). In that case, the adapter may be designed to be adhesively bonded to the outer surface of the pipeline or conduit, e.g., via a contact adhesive or adhesive tape applied between opposed surfaces thereof. In the latter case, the adapter may include a clip, e.g., with jaws, designed to receive and to clasp or to grip part of a fixture or fitting of a pipeline or conduit (e.g., a junction component, such as a ferrule for a water pipeline or a gas pipeline).

In an embodiment, the elongate member has one or more indicia or markings along its length to indicate a distance to, or a further depth of, the end which is secured to the infrastructure asset. In this way, as the depth indicator device is revealed during the excavation process, the elongate member will show the workers via the one or more indicia or markings the further distance or depth to the buried asset being excavated.

In an embodiment, the elongate member is coloured, desirably brightly coloured e.g., in a fluorescent yellow or green or pink, to be readily visible in the ground against the colour of the earth during the excavation process. A particular colour may be used as colour-coding to designate or indicate a specific type of infrastructure asset—e.g., water, gas, electrical, optical fibre, sewerage.

In an embodiment, the elongate member includes at least one fracture line or line of weakness at which the elongate member is designed to break transversely across its length upon receipt of an impact, e.g., if struck by the hydraulic shovel digging during the excavation process. In this regard, the elongate member may have a series of fracture lines or lines of weakness spaced apart at intervals along the length of the elongate member, such that the elongate member will break transversely of its length at one of the fracture lines, or lines of weakness, upon receipt of an impact at or close to that one of the fracture lines or lines of weakness.

In an embodiment, each fracture line or line of weakness forms a marking along a length of the elongate member to indicate a distance to, or a further depth of, the end region secured to the infrastructure asset. The fracture lines spaced at intervals along a length of the elongate member may thus form the indicia to indicate the distance to, or further depth of, the buried asset. In this way, as a hydraulic shovel digs, an uppermost portion (e.g., 200 mm or 300 mm in length) of the elongate member might be struck and broken off to indicate, for example, that a further 600 mm of the indicator device extends to the buried asset.

In an embodiment, the elongate member is less than or equal to about 2 metres in length. The elongate member may have a length in the range of about 300 mm to about 1500 mm, or in the range of about 800 mm to about 1000 mm.

According to another aspect, the disclosure also provides an adapter configured for connecting or coupling an end of an elongate member of a depth indicator device according to any one of the embodiments of the disclosure described above to an outer surface of a pipeline or conduit directly or to a fixture or fitting or junction component of a pipeline or conduit.

In this regard, the adapter may be designed for connection with a coupling element at a lower end of the elongate member of the depth indicator device. In an embodiment, for example, the adapter presents an upper surface configured to connect with a coupling element at a lower end of the elongate member of the depth indicator device. The upper surface may be configured to be attached or connected to an underside of a laterally extending member (e.g., a plate member) at the lower end of the elongate member, e.g., by one or more fasteners or by adhesive bonding, such as via adhesive cement or adhesive tape to be applied between the opposed surfaces thereof.

In an embodiment, the adapter is configured to be attached or connected to an outer surface of the pipeline or conduit. In this regard, the adapter may be configured to seat against the outer surface of the pipeline or conduit. To this end, the adapter may define a recess adapted to receive and/or accommodate part of the outer surface of the pipeline or conduit, so that the adapter seats directly against the pipeline or conduit in the manner of a saddle. The adapter may be designed to be adhesively bonded to the outer surface of the pipeline or conduit, for example, via a contact adhesive or adhesive tape to be applied between opposed surfaces thereof.

In an embodiment, the adapter is configured to be attached or connected to a fixture or fitting or junction component of a pipeline or conduit. In that case, the adapter may include a clip, e.g., with jaws, designed to receive and to clasp or to grip part of a fixture or fitting of a pipeline or conduit (e.g., a junction component, such as a ferrule for a water pipeline or a gas pipeline).

According to yet another aspect, the disclosure provides a kit comprising a fixture or fitting or junction component for a pipeline, such as a ferrule for a water pipeline or for a gas pipeline, and an adapter configured for connecting or coupling a depth indicator device according to any one of the embodiments of the disclosure described above to that fixture or fitting or junction component.

In this way, when ferrules and/or other fixtures or fittings are being installed for connecting new homes in new housing estates or housing developments to the main water and/or main gas supply pipeline, each ferrule of fixture may be provided with its own adapter for connecting or coupling to a depth indicator device. The depth indicator device itself may optionally be sold with the ferrules (or other fixtures/fittings) also or may be sold separately to be installed with them. If and when any maintenance or repair work is required in the future on the pipeline, it should therefore be possible for workers to excavate that ferrule or fixture with a very low risk of inadvertent damage to the ferrule or to the main supply pipeline during the excavation process.

According to still another broad aspect, the disclosure provides a depth indicator device for protecting a buried asset from inadvertent damage, e.g., by heavy machinery, during excavation, especially a buried infrastructure asset, such as a water or gas pipeline or an electrical conduit or optical fibre conduit. The depth indicator device comprises an elongate member, such as a rod or stick, with an end region adapted to be secured to the buried asset, wherein the elongate member is configured to extend upwards from the asset a predetermined distance towards a surface of the ground, and wherein, when exposed during excavation of the asset, the elongate member is adapted to indicate a distance to, and/or a further depth of, the buried asset.

According to a further aspect, the disclosure provides a method of protecting a buried infrastructure asset, such as a water or gas pipeline or electrical conduit buried in the ground for building services, the method including installing or deploying a depth indicator device according to any of the embodiments of the disclosure described above on or in connection with the buried asset.

### BRIEF DESCRIPTION OF THE FIGURES

For a more complete understanding of the disclosure, exemplary embodiments of the disclosure are explained in more detail in the following description with reference to the accompanying drawing figures, in which like reference signs designate like parts and in which:

FIG. 1 is a schematic side view of a depth indicator device according to an embodiment of the disclosure installed on a buried infrastructure asset in the ground during an excavation;

FIG. 2 is a schematic perspective side view of a depth indicator device according to an embodiment of the disclosure;

FIG. 3 is a schematic perspective view of an adapter according to an embodiment of the disclosure for connecting or coupling a depth indicator device according to an embodiment to a fixture, e.g., a ferrule, for a pipeline buried in the ground; and

FIG. 4 is a schematic perspective view of four adapters (a) to (d) for connecting or coupling a depth indicator device of an embodiment to an outer surface of different sized pipelines or conduits.

The accompanying drawings are included to provide a further understanding of the present disclosure and are incorporated in and constitute a part of this specification. The drawings illustrate particular embodiments of the disclosure and, together with the description, serve to explain the principles of the disclosure. Other embodiments of the disclosure and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. Furthermore, it will be noted that the elements of the drawings are not necessarily illustrated to scale relative to each other. It will also be understood that certain actions or steps in an embodiment of a method may be described or depicted in a particular order of occurrences while those skilled in the art will understand that such specificity with respect to sequence is not actually required.

### DETAILED DESCRIPTION

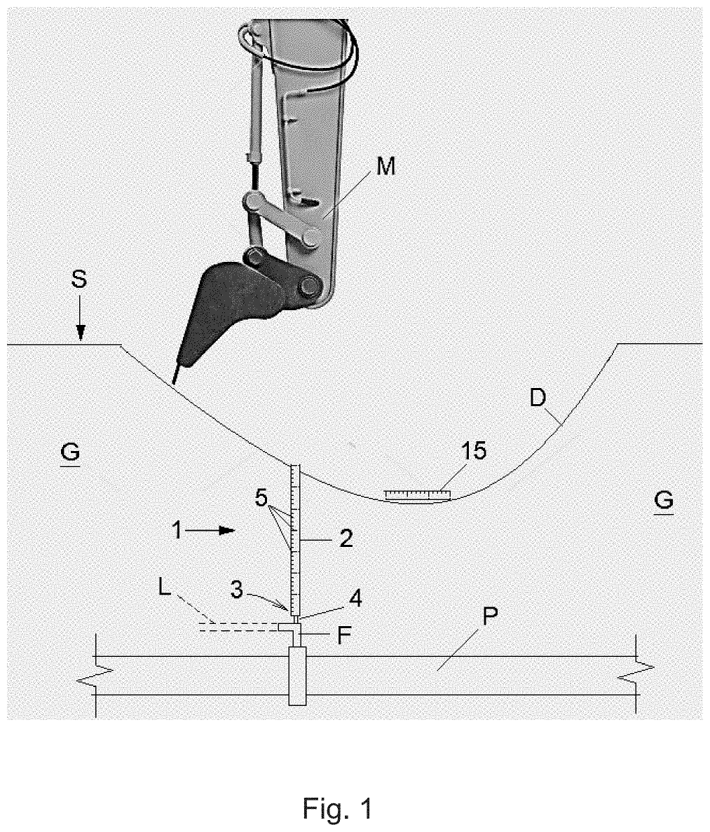

With reference to FIG. 1 of the drawings, a depth indicator device 1 according to an embodiment is shown installed or deployed in the ground in connection with a mains water supply pipeline P. The mains water supply pipeline P supplies water to a number of residential or commercial properties and has a fitting or fixture in the form of a ferrule F for connecting an individual property to the pipeline P via supply line L. The depth indicator device 1 comprises an elongate member 2 in the form of a rod or stick, one end 3 of which is secured to the pipeline P at the ferrule F. To this end, the device 1 includes a connector or coupling 4 for securing the lower end region 3 of the elongate member 2, i.e., the rod or stick, at the ferrule F. The rod or stick 2 is generally straight and stiff with a predetermine length so that it can be arranged to extend upwards from the ferrule F a predetermined distance towards a surface S of the ground G. The rod or stick 2 of the depth indicator device 1 further includes indicia or markings 5 along its length to indicate in increments a distance or a further depth to the ferrule F and to the connector or coupling 4 secured to the ferrule F at the lower end region 3 of the rod or stick 2.

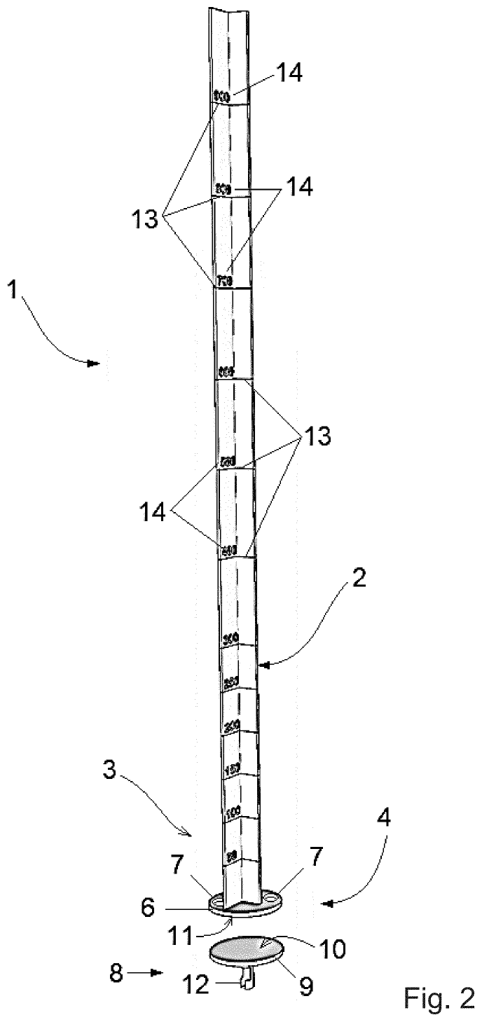

With reference also now to FIG. 2 of the drawings, the depth indicator device 1 is illustrated in more detail. The elongate member 2 (i.e., the rod or stick) of the depth indicator device 1 in this embodiment has a substantially constant L-shaped transverse cross-section or profile. The rod or stick 2 is comprised of a polymer plastic material, such as polyethylene (PE), polypropylene (PP). polyvinyl chloride (PVC), polyurethane (PU), or similar, and may be brightly coloured (e.g., a bright or fluorescent yellow or green colour) so as to be readily visible in the ground during an excavation. The lower end region 3 of the elongate member 2 includes a laterally extending member 6 in the form of a disc-shaped plate 6 which may form part of the connector or coupling 4 to be secured to the ferrule F or to the outside of the pipeline P directly. It will be noted, for example, that one or more holes or apertures 7 may be provided in the plate member 6 for receiving a fastening band, such as a cable-tie (not shown). The fastening band can be passed through the holes 7 and secured around the ferrule F or around the outside of the pipeline P. Alternatively, the connector or coupling 4 can include an adapter 8 that is designed to interface with the disc-shaped plate member 6 at the lower end 3 of the rod or stick 2 and connect same to the fixture or ferrule F on the pipeline P. To this end, the adapter 8 includes a plate member 9 with an upper surface 10 designed to contact and to be adhesively bonded to an underside surface 11 of the plate 6. A fast-acting gel or liquid adhesive may be used for this purpose, but a swatch or patch of double-sided adhesive tape (e.g., from 3M™) applied between opposed surfaces 10, 11 may be used. The adapter 8 further includes a clip 12 with resilient or elastic jaws designed to receive and clasp or hold the ferrule F. As an alternative to providing the adapter 8, it will be noted that the clip 12 could also be provided directly on an underside of the plate 6. However, as will become apparent later with reference to FIG. 4, the benefit of using an adapter 8 is that the same depth indicator device 1 can be deployed on either a fixture F or on the outer surface of the pipeline P itself.

As can be seen in FIG. 2, the indicia or markings 5 along the length of the rod or stick 2 include both spaced or incremental lines 13 and numbers 14 specifying distance in millimetres (mm) along the rod or stick 2 from an adjacent line 13 to the connector or coupling 4 and/or to the ferrule F. In this embodiment, the elongate member 2 (i.e., rod or stick) has a length of 1 metre and is marked with lines 13 and numbers 14 specifying incremental distances of 900 mm, 800 mm, 700 mm, 600 mm, 500 mm, 400 mm, 300 mm, 250 mm, 200 mm, 150 mm, 100 mm and 50 mm to the lower end 3 at which the connector or coupling 4 is secured to the ferrule F. Each spaced or incremental line 13 marking the distance specified by the adjacent number 14 also forms or comprises a fracture line or line of weakness across the rod or stick 2. The elongate rod or stick 2 is therefore designed to break transversely across its length at the fracture lines 13 upon receipt of an impact in the vicinity of one of those lines 13 during excavation. An upper portion 15 of the rod or stick 2 that is broken off along a line of weakness 13 bears the numbers 14 that specify the length of the rod or stick 2 still attached to the ferrule F or pipeline P below.

Referring again to FIG. 1 of the drawings, it will be appreciated that excavation of the ground G is usually performed with heavy machinery M, e.g., a hydraulic powered shovel, when access to the supply pipeline P is required at the fixture or ferrule F for maintenance or repair purposes. As the shovel of the machinery M excavates a ditch D towards the supply pipeline P in the vicinity of the ferrule F, the shovel strikes the depth indicator device 1 and breaks the elongate member 2 at one of the fracture lines 11 to leave a broken portion 15 of the rod or stick 2 in the ditch D. The broken portion 15 is brightly coloured and so can be easily seen by the workers conducting the excavation. In this way, the depth indicator device 1 provides a forewarning that alerts the workers to the proximity of the pipeline P and ferrule F within a predetermined distance or depth. This allows them to adjust further excavating activity to take greater care and to protect the buried pipeline P and ferrule F from inadvertent damage by the heavy machinery M.

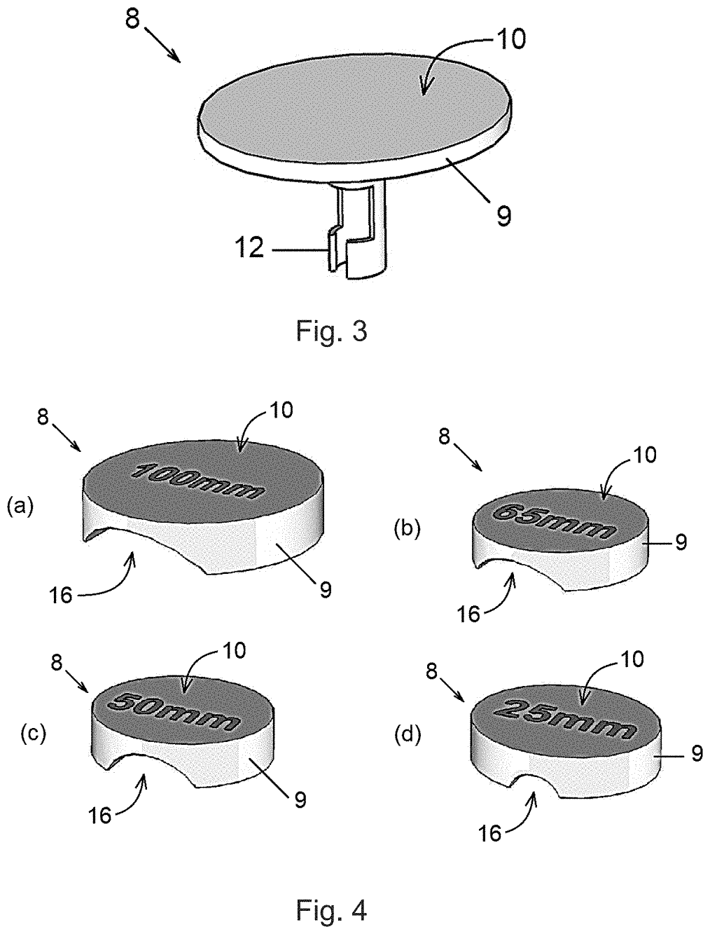

With reference to FIG. 3 of the drawings, an adapter 8 of the disclosure described above for use with a fixture or ferrule F is shown separately. The adapter 8 of FIG. 3 can be combined in a kit with the fixture or fitting (e.g., ferrule F) for installation together in a water pipeline or a gas pipeline. The adapter 8 is configured for connecting or coupling a depth indicator device 1 as shown in FIG. 2 to the ferrule F.

Referring to FIG. 4 of the drawings, four different versions of another adapter 8 are illustrated as (a) to (d) for connecting or coupling a depth indicator device 1 as seen in FIG. 2 to the outer surface of the pipeline P directly. It will be appreciated that a water or gas supply pipeline P or an electrical conduit or optical fibre conduit could potentially require maintenance or repair anywhere along its length if a fault or damage were to occur. For that reason, it may be desirable to have a series of depth indicator devices 1 secured to the pipeline P at spaced intervals along its length, rather than only at fixtures or fittings F. The adapters 8 shown in FIG. 4 are designed for this purpose. Similar to the adapter 8 shown in FIG. 3, each of the adapters 8 shown in (a) to (d) of FIG. 4 includes a plate member 9. Instead of a clip 12 depending from an underside of that plate member, however, these adapters 8 include a curved recess 16 formed in an underside thereof. In each case (a) to (d) the curved recess 16 is of a different size, with the size matched to a common diameter of a pipeline or conduit P used for infrastructure assets, the size marked on the upper surface 10 of each plate member 9. Thus, the curved recess 16 is configured to receive and accommodate part of the outer surface of the pipeline P, so that the adapter 8 may seat directly against an upper side of the pipeline or conduit P in the manner of a saddle. By applying an adhesive in curved recess 16, such as in the form of a swatch or patch (not shown) of double-sided adhesive tape (e.g., from 3M™), the adapter 8 can then be securely bonded to the upper side of the outer surface of the pipeline or conduit P. As for the adapter 8 shown in FIG. 3, the upper surface 10 of the plate member 9 is designed for engaging and supporting a depth indicator device 1 as shown in FIG. 2 via the underside surface 11 of the connecting plate 6 at the lower end 3 of the elongate rod or stick 2.

It will be understood that, in certain instances, the infrastructure asset may not require any adapter member 8. For example, some buried infrastructure assets present a flat upper surface to which the plate member 6 of a depth indicator device 1 as shown in FIG. 2 may be directly bonded. An example includes sewer traps on properties, which are typically buried at a depth in the range of 1 to 5 metres. The sewer traps typically include an inspection opening cap at the top thereof, which inspection opening caps are usually level or horizontal and have a diameter of about 100 mm—i.e., about the same size as the disc-shaped plate member 6. Thus, when the depth indicator device 1 seen in FIG. 2 is used or deployed on a sewer trap, the disc-shaped plate member 6 may be supported on and secured directly to the inspection opening cap in the same manner as described above.

Although specific embodiments of the disclosure are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the present disclosure and their legal equivalents. Generally, this application is intended to cover any adaptations or variations of the specific embodiments discussed herein.

It will also be appreciated that the terms “comprise”, “comprising”, “include”, “including”, “contain”, “containing”, “have”, “having”, and variations thereof used in this document are, unless the context indicates otherwise, intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, device, apparatus, or system. Further, the terms “a” and “an” used herein are intended to be understood as meaning one or more unless explicitly stated otherwise. Moreover, the terms “first”, “second”, “third” etc. are used merely as labels and are not intended to impose any numerical requirements on or to establish any ranking of importance of their objects. In addition, reference to positional terms, such as “lower” and “upper”, used in the above description are to be taken in context of the embodiments depicted in the figures, and are not to be taken as limiting the disclosure to the literal interpretation of the term but rather as would be understood by the skilled addressee in the appropriate context.

### REFERENCE SIGNS

1 depth indicator device

2 elongate member or rod or stick

3 lower end region of elongate member

4 connector or coupling

5 indicia or markings

6 plate member

7 hole or aperture

8 adapter

9 plate member

10 upper surface

11 underside surface

12 clip

13 marking line and/or fracture line or line of weakness

14 number

15 broken off portion of elongate member

16 curved recess

P supply pipeline

F fitting or fixture or ferrule

L supply line

G ground

S ground surface

M heavy machinery and shovel

D ditch

1. A depth indicator device for protecting a buried asset, such as an infrastructure asset, from inadvertent damage during an excavation, the device comprising:
an elongate member having an end region configured to be secured to an asset installed below ground, wherein the elongate member is configured to extend a predetermined distance upwards from the infrastructure asset towards a surface of the ground;
whereby, when exposed during an excavation of the infrastructure asset, the elongate member is adapted to indicate a distance to, or a further depth of, the buried infrastructure asset.

2. The depth indicator device according to claim 1, wherein the elongate member is a substantially integral or unitary member.

3. The depth indicator device according to claim 1, wherein the elongate member is relatively rigid and relatively straight.

4. The depth indicator device according to claim 1, wherein the elongate member has a substantially constant transverse cross-section or profile, and wherein the transverse cross-section or profile is one of: I-shaped, L-shaped, C-shaped, X-shaped, Y-shaped, Z-shaped, or circular.

5. The depth indicator device according to claim 1, further comprising a connector or coupling element for securing the end region of the elongate member to the infrastructure asset.

6. The depth indicator device according to claim 5, wherein the connector or coupling element is attached to the end region of the elongate member, and wherein the connector or coupling element comprises a laterally extending member adapted to seat against a pipeline or conduit of the infrastructure asset, wherein the laterally extending member (plate member) may be adapted to be adhesively bonded to the pipeline or conduit, e.g., via an adhesive tape or cement applied between opposing surfaces thereof.

7. The depth indicator device according to claim 5, wherein the connector or coupling element includes a clip or a tie or an adhesive strip for securely fastening or connecting the end region of the elongate member to the infrastructure asset.

8. The depth indicator device according to claim 1, wherein the elongate member includes indicia or markings along its length to indicate a distance to, or a further depth of, the infrastructure asset.

9. The depth indicator device according to claim 1, wherein the elongate member includes at least one fracture line or line of weakness at which the elongate member is designed to break transversely across its length upon receipt of an impact.

10. The depth indicator device according to claim 9, including a series of fracture lines or lines of weakness spaced apart at intervals along the length of the elongate member, wherein the elongate member is adapted to break transversely across its length at one of the fracture lines or lines of weakness upon receipt of an impact at or close to said one of the fracture lines or lines of weakness.

11. The depth indicator device according to claim 9, wherein each fracture line or line of weakness forms a marking along a length of the elongate member to indicate a distance to or further depth of the infrastructure asset.

12. The depth indicator device according to claim 1, wherein the elongate member is comprised of a polymer plastic material, such as high-density polyethylene (HDPE), polyethylene (PE), polypropylene (PP), polyvinyl chloride (PVC), polyurethane (PU), or the like.

13. The depth indicator device according to claim 1, wherein the elongate member is coloured to be readily visible in the ground during excavation.

14. The depth indicator device according to claim 1, wherein the elongate member is selectively collapsible or extendible for ease of handling when not deployed.

15. An adapter for connecting or coupling an end of an elongate member of a depth indicator device of claim 1 to an outer surface of a pipeline or conduit directly or to a fixture or fitting of a pipeline or conduit.

16. The adapter according to claim 15, the adapter having or presenting an upper surface configured for connecting with a coupling element provided at a lower end of the elongate member of the depth indicator device.

17. The adapter according to claim 15, wherein the adapter is configured to seat against and to be attached or connected directly to an outer surface of the pipeline or conduit, the adapter including a recess adapted to receive and/or accommodate part of the outer surface of the pipeline or conduit, such that the adapter seats directly against the pipeline or conduit in the manner of a saddle, wherein the adapter is designed to be adhesively bonded to the outer surface of the pipeline or conduit via an adhesive tape to be applied between opposed surfaces thereof.

18. The adapter according to claim 15, wherein the adapter is configured to be attached or connected to a fixture or fitting on a pipeline or conduit, the adapter including a clip designed to receive and clasp or grip part of the fixture or fitting.

19. A kit comprising a fixture or a fitting for a pipeline, such as a ferrule for a water supply pipeline or a gas supply pipeline, and an adapter configured to connect or couple a depth indicator device according to claim 1 to said fixture or fitting.

20. A method of protecting a buried infrastructure asset, such as a water pipeline or a gas pipeline or an electrical conduit buried in the ground for building services, the method including installing or deploying at least one depth indicator device according to claim 1 on or in connection with the infrastructure asset.
